(19) United States
(12) Patent Application Publication
(10) Pub. No.: US 2006/0056614 A1
(43) Pub. Date: Mar. 16, 2006

(54) Voice mail for teleconference

(75) Inventor: Tom Chiu, Sunnyvale, CA (US)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: Koninklijke Philips Electronics N.V., BA Eindhoven (NL)

(21) Appl. No.: 10/537,362

(22) PCT Filed: Dec. 4, 2003
(86) PCT No.: PCT/IB03/05598

§ 371 Date: Jun. 2, 2005

Related U.S. Application Data
(60) Provisional application No. 60/431,436, filed on Dec. 6, 2002.

(51) Int. Cl. H04M 3/42; H04M 11/00

(52) U.S. Cl. 379/202.01; 379/88.16

(57) ABSTRACT

Messaging services (160) are provided in conjunction with teleconferencing services (150). After assigning a dial-in number to a scheduled teleconference, invitees (111) can use this dial-in number to record messages (260) prior to, or during, the scheduled teleconference. When the teleconference is established (310), a participant (110) in the teleconference, typically the originator of the teleconference, is provided the option (330) of playing-back any or all of the recorded messages, either privately (340), or as part of the teleconference (350). Optionally, messages can be addressed to one or more specific participants (110, 111), and these participants control the playback of the message. If the message is received during the teleconference, the addressed participant is discretely notified (320), and can subsequently playback the message immediately, or at a more convenient time.

This invention relates to the field of communications, and in particular to a teleconference system that supports voice mail.

A conventional teleconference is established by scheduling a date and time for the teleconference with a service provider, receiving a ‘call-in’ telephone number from the service provider, and notifying each invitee to the teleconference of the date, time, and call-in telephone number. At the date and time of the teleconference, each invitee calls the call-in telephone number, and is admitted to the teleconference, typically after providing an authorization passcode. Alternatively, the organizer of the teleconference provides the service provider with contact information for some or all of the invitees, and the service provider calls each of these invitees at the date and time of the teleconference.

Conventionally, if an invitee is not able to ‘attend’ the teleconference, the invitee contacts the organizer of the teleconference, or contacts another invitee, to inform the participants of his or her unavailability. In some instances, this can be problematic. For example, the invitee may not want to impose upon the organizer or other invitee to pass along his or her unavailability message; the organizer or other invitee may forget that the invitee conveyed his or her unavailability; the organizer or other invitee may not appropriately convey the invitee's reasons for not attending; and so on.

In some instances, the invitee may intend to attend the teleconference, but is prevented from attending by an unforeseen event. The invitee may not have the opportunity to notify the participants until after the teleconference is in progress, and interrupting the teleconference merely to inform the participants of the invitee's unavailability may be disruptive and/or inappropriate.

It is an object of this invention to provide a method and system that allows an invitee to a teleconference to convey a message directly to the participants at the teleconference. It is a further object of this invention to allow the invitee to transmit this message at any time prior to, or during, the teleconference. It is a further object of this invention to allow the participants to receive this message at their convenience.

These objects, and others, are achieved by providing messaging services in conjunction with teleconferencing services. After assigning a dial-in number to a scheduled teleconference, invitees can use this dial-in number to record messages prior to, or during, the scheduled teleconference. When the teleconference is established, a participant in the teleconference, typically the originator of the teleconference, is provided the option of playing-back any or all of the recorded messages, either privately, or as part of the teleconference. Optionally, messages can be addressed to one or more specific participants, and these participants control the playback of the message. If the message is received during the teleconference, the addressed participant is discretely notified, and can subsequently playback the message immediately, or at a more convenient time.

The invention is explained in further detail, and by way of example, with reference to the accompanying drawings wherein:

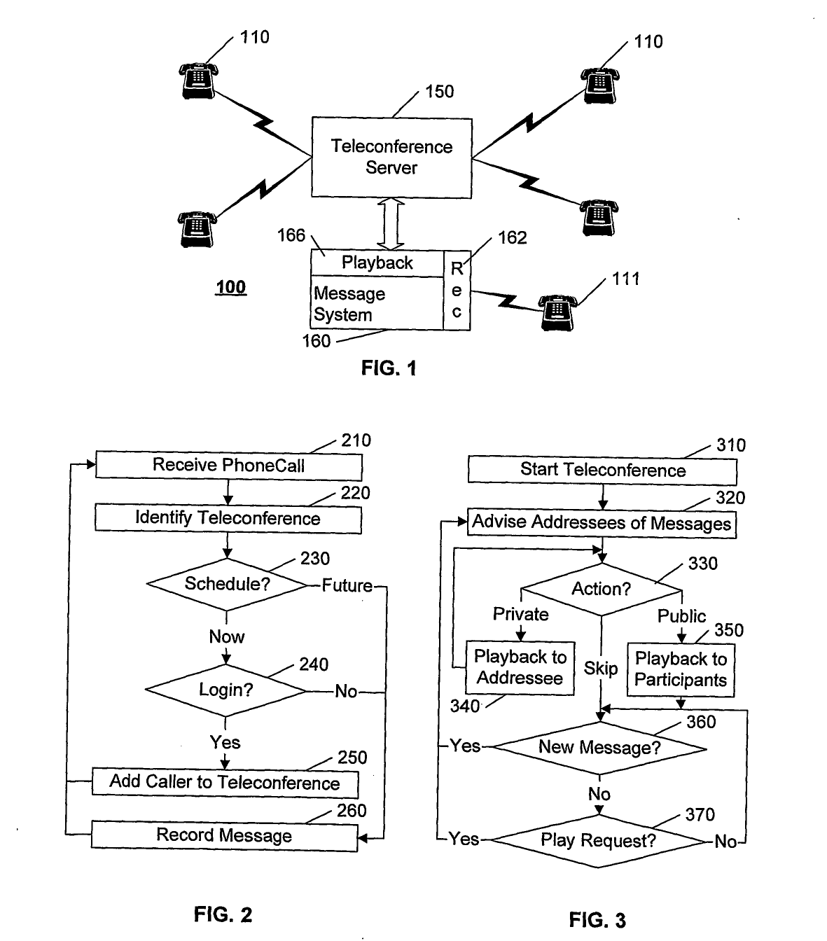

FIG. 1 illustrates an example teleconference service system in accordance with this invention.

FIG. 2 illustrates an example flow diagram for receiving messages in a teleconference service system in accordance with this invention.

FIG. 3 illustrates an example flow diagram for presenting messages in a teleconference service system in accordance with this invention.

Throughout the drawings, the same reference numerals indicate similar or corresponding features or functions.

FIG. 1 illustrates an example teleconference service system 100 in accordance with this invention. The service system 100 includes a conventional teleconference server 150 and an associated message system 160. Preferably, the message system 160 is integral to the server 150, but as will be evident to one of ordinary skill in the art in view of this disclosure, the message system 160 could be provided by a third party, via an appropriate interface to the server 150.

The teleconference server 150 is configured to provide teleconferencing services to a plurality of participants 110. The participants 110 are symbolized by telephone instruments in FIG. 1, although other instruments, including video cameras and displays, may also be used by the participants 110.

As in a conventional teleconference system, the server 150 is configured to establish the teleconference at a predetermined date and time. U.S. Pat. No. 5,483,588, “VOICE PROCESSING INTERFACE FOR A TELECONFERENCE SYSTEM”, issued 9 Jan. 1996 to Eaton et al., discloses a number of capabilities and services offered by a typical teleconference server and is incorporated by reference herein.

As contrast to a conventional teleconferencing system, however, the teleconferencing system 100 of this invention is configured to recognize a future teleconference as a logical entity, to which messages can be attached. That is, in a conventional teleconference system, the phone numbers that are assigned to the teleconferences are used repeatedly for different teleconferences, and a call to the assigned call-in number for a teleconference at a date and time that differs substantially from the scheduled time of the teleconference will likely result in a connection to a different teleconference, absent a security protocol that limits such mistaken connections.

In accordance with this invention, a message system 160 is configured to allow teleconference invitees 111 to leave messages for subsequent delivery to the participants 110 of the teleconference. The message system 160 includes a receiver/recorder 162 that is configured to receive and record messages intended for specific teleconferences, and a playback device 166 that is configured to play back the messages during the teleconference. As discussed further below, the playback device 166 is preferably configured to selectively provide playback to all of the participants of the teleconference, or only to the identified receiver of the message.

FIG. 2 illustrates an example flow diagram for receiving messages in a teleconference service system in accordance with this invention. At 210, a phone call is received by the teleconference system, and at 220, the caller identifies the particular teleconference. In a conventional teleconference system, a security code is assigned to each teleconference, to prevent the aforementioned accidental, or purposeful, connection to an unauthorized teleconference. In a preferred embodiment of this invention, this security code is used to uniquely identify the proper teleconference. If the security code is invalid, or is expired because the teleconference has terminated or has been cancelled, the caller is so advised, and the process terminates (not illustrated).

At 230, the current date and time is compared to the scheduled time of the teleconference. If the current date and time is substantially ahead of the scheduled time, the teleconference system provides the caller the option of leaving a message for delivery to the teleconference attendees, at 260. The caller is provided the option of specifying a particular addressee of the message. In a preferred embodiment, the teleconference system either vocalizes each name in the list of invitees and waits for an affirmative response by the caller, or the caller is given the option of “spelling” the addressee's name via the telephone keypad until the system recognizes the name from the list of invitees.

If the current date and time substantially corresponds to the scheduled time, the caller is given the option of logging into the conference as a participant, at 250, or leaving a message as a non-participant, at 260.

By allowing an invitee to leave a message, the invitee is able to notify the participants of his or her inability to attend, or, the invitee can send a brief message to the participants without having to join the teleconference and then leave soon thereafter. This latter feature can be used, for example, by a CEO, or Sales VP to leave a message of congratulations, or encouragement, for playback during an engineering teleconference.

FIG. 3. illustrates an example flow diagram for presenting messages in a teleconference service system in accordance with this invention. At 310, the teleconference is started, typically by the organizer of the teleconference advising the teleconference service provider that the meeting is about to start. At this time, or at a time identified by the organizer, any messages that have been associated with this meeting are presented to their addressees, at 320. If a message does not have an explicit addressee, it is delivered to the organizer, by default. Optionally, the organizer can delegate the task of receiving messages to other participants in the teleconference.

In a preferred embodiment, the message system presents the messages to each addressee using the common techniques of a conventional voice-mail system, with the additional option of selecting playback of the message in ‘public’ or ‘private’ form, at 330. In the private form, at 340, the playback is presented solely to the addressee; in the public form, at 350, the playback is presented to all the participants of the teleconference. After a private listening, at 340, the addressee is again given the option, at 330, of presented the message publicly, or skipping a repeat playback.

The loop 320 through 360 is repeated for each stored message, or for any subsequently received message. At 370, addressees are provided the option of re-accessing the voice-mail system options at 320, to replay messages, or to play messages that had been skipped over.

The system continues to loop through blocks 360-370 for the duration of the teleconference. If a new message arrives, the addressee is advised of its arrival, at 320. In a preferred embodiment, after the initial messages are processed, the notification to the addressee is unobtrusive, using a short beep or tone to notify the addressee, and then automatically progressing through the ‘skip’ path back to the loop 360-370 until the addressee specifically requests a re-access to the voice-mail options, at 370.

The foregoing merely illustrates the principles of the invention. It will thus be appreciated that those skilled in the art will be able to devise various arrangements which, although not explicitly described or shown herein, embody the principles of the invention and are thus within the spirit and scope of the following claims.

1. A teleconference system comprising: a teleconference server that is configured to provide communications among a plurality of participants in a teleconference, and a message system, operably coupled to the teleconference server, that is configured to receive and record messages intended for delivery to the teleconference.

2. The teleconference system of claim 1, wherein the participants access the teleconference using an assigned call-in telephone number for the teleconference, and the message system receives the messages via the assigned call-in telephone number.

3. The teleconference system of claim 1, wherein the participants access the teleconference using an assigned identification code of the teleconference, and the message system associates the messages to the teleconference based on submission of the assigned identification code.

4. The teleconference system of claim 1, wherein the message system is configured to receive and record the messages during a time period between a first time and a second time, the first time being substantially before a commencement of the teleconference, the second time corresponding to one of: the commencement of the teleconference, and a termination of the teleconference.

5. The teleconference system of claim 1, wherein the message system is further configured to allow identification of one or more addressees of each of the messages.

6. The teleconference system of claim 1, wherein the message system is further configured to enable playback of the messages during the teleconference.

7. The teleconference system of claim 6, wherein the message system is configured to enable the playback in: a public mode, wherein the playback is provided to the plurality of participants, and a private mode, wherein the playback is provided to one or more select participants of the plurality of participants.

8. The teleconference system of claim 7, wherein the one or more select participants are determined based on an identification of one or more addressees of each of the messages.

9. A message system for communicating messages to a teleconference, comprising: a receiver that is configured to receive and store messages for delivery to the teleconference, and a playback device that is configured to playback the messages during the teleconference.

10. The message system of claim 9, wherein participants access the teleconference using an assigned call-in telephone number for the teleconference, and the receiver receives the messages via the assigned call-in telephone number.

11. The message system of claim 9, wherein the participants access the teleconference using an assigned identification code of the teleconference, and the receiver associates the messages to the teleconference based on submission of the assigned identification code.

12. The message system of claim 9, wherein the receiver is configured to receive and record the messages during a time period between a first time and a second time, the first time being substantially before a commencement of the teleconference, the second time corresponding to one of: the commencement of the teleconference, and a termination of the teleconference.

13. The message system of claim 9, wherein the receiver is further configured to allow identification of one or more addressees of each of the messages.

14. The message system of claim 9, wherein the playback device is configured to enable the playback in: a public mode, wherein the playback is provided to the plurality of participants, and a private mode, wherein the playback is provided to one or more select participants of the plurality of participants.

15. The message system of claim 14, wherein the one or more select participants are determined based on an identification of one or more addressees of each of the messages.

16. A method of providing message services to a teleconference, including: receiving a message for delivery to the teleconference, storing the message, and playing back the message during the teleconference.

17. The method of claim 16, wherein participants access the teleconference using an assigned call-in telephone number for the teleconference, and receiving the message is via the assigned call-in telephone number.

18. The method of claim 16, wherein participants access the teleconference using an assigned identification code of the teleconference, and storing the message is based on submission of the assigned identification code.

19. The method of claim 16, wherein receiving the message occurs during a time period between a first time and a second time, the first time being substantially before a commencement of the teleconference, the second time corresponding to one of: the commencement of the teleconference, and a termination of the teleconference.

20. The method of claim 16, wherein playing back the message selectively includes: playing back the message to a plurality of participants of the teleconference, and playing back the message to one or more select participants of the plurality of participants.

21. The method of claim 20, wherein the one or more select participants are determined based on an identification of one or more addressees of the message.
